(19) United States
(12) Patent Application Publication
(10) Pub. No.: US 2007/0080906 A1
(43) Pub. Date: Apr. 12, 2007

(54) Display apparatus with active matrix display panel, and method for driving same

(75) Inventor: Takahisa Tanabe, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Tokyo (JP)

(21) Appl. No.: 10/574,100

(22) PCT Filed: Sep. 29, 2004
(86) PCT No.: PCT/JP04/14712

§ 371 Date: Aug. 30, 2006

(30) Foreign Application Priority Data
Oct. 2, 2003 (JP) 2003-344256

(51) Int. Cl. G09G 3/30

(52) U.S. Cl. 345/76

(57) ABSTRACT

A display apparatus with an active matrix display panel which can suppress gate stress to prevent a degradation of the display quality. Specified at least one pixel section having a light emitting element to driven for light emission in one row is supplied with a data pulse indicative of a first gate voltage of a thin film transistor upon supply of a display scanning pulse. Subsequently, each pixel in the one row is supplied with a reset scanning pulse, and when supplying a reset scanning pulse, the at least one pixel section is supplied with a reset pulse indicative of a second gate voltage of the thin film transistor for making the polarity of agate-to-source voltage or gate-to-drain voltage of the thin film transistor reverse to that during light emission driving.

### TECHNICAL FIELD

The present invention relates to a display apparatus with an active matrix display panel, and a method for driving the active matrix display panel.

### BACKGROUND ART

For an active matrix display using light emitting elements, TFT (Thin Film Transistor) using poly-crystal silicon, amorphous silicon (a-Si), organic semiconductor, or the like is used as a driving element for each pixel. It has been known that TFT using amorphous silicon or organic semiconductor has a phenomenon that a threshold voltage Vth shifts when the gate is continuously applied with a voltage, i.e., gate stress (for example, see S. J. Zilker, C. Detcheverry, E. Cantatore, and D.M. de Leeuw: APPLIED PHYSICS LETTERS VOLUME 79, NUMBER 8, 20 AUG. 2001, “Bias stress in organic thin-film transistors and logic gates”). This phenomenon will be described giving a P-channel TFT as an example. FIGS. 1A and 1B show how the gate threshold voltage Vth shifts due to gate stress. In the P-channel TFT, as a gate-to-source voltage Vgs, which is set negative, is continuously applied, the gate threshold voltage Vth changes in the minus direction over time due to the gate stress, as shown in FIG. 1A, and therefore gradually shifts from Vth1 to Vth2, for example, as shown in FIG. 1B. This change returns to the original Vth by continuously applying Vgs set at 0 V or a positive voltage. Conversely, as the voltage Vgs, which is set positive, is continuously applied, Vth shifts in the plus direction over time, and the original Vth is recovered by continuously applying Vgs set at 0 V or a negative voltage. The amount of shift is larger as the absolute value of Vgs and an application time are larger. When TFT exhibiting such characteristics is used for driving an organic EL element, Vth gradually shifts for a display period.

In a conventional driving method, since a driving voltage and driving conditions must be set in consideration of variations in Vth due to the gate stress in addition to variations in the initial value of Vth, the driving voltage is increased to cause larger power consumption. Also, as variations in Vth become larger, an error of a driving current becomes larger, even if a circuit is used for correcting it, resulting in a disadvantage of degrading the display quality.

### DISCLOSURE OF THE INVENTION

It is an object of the present invention to provide a display apparatus with an active matrix display panel which is capable of suppressing gate stress to prevent a degradation of the display quality, and a method of driving the same.

A display apparatus according to the present invention is a display apparatus with an active matrix display panel having a plurality of pixel sections each including a light emitting element and a thin film transistor, the display apparatus comprising: a power supply for supplying a supply voltage to the plurality of pixel sections; and display control means for sequentially specifying one of a plurality of rows of the display panel at a predetermined timing for each frame and at least one pixel section including a light emitting diode to be driven for light emission in the one row, supplying a display scanning pulse to each pixel section in the one row, supplying a data pulse indicative of a first gate voltage of the thin film transistor to the at least one pixel section when supplying the display scanning pulse, subsequently supplying a reset scanning pulse each of the pixel sections in the one row, and supplying a reset pulse to the at least one pixel section when supplying the reset scanning pulse, the reset pulse indicating a second gate voltage of the thin film transistor for making the polarity of agate-to-source voltage or gate-to-drain voltage of the thin film transistor reverse to the polarity during light emission driving, wherein each of the plurality of pixel sections has a driving unit for supplying a gate of the thin film transistor with the first gate voltage corresponding to the data pulse in response to the display scanning pulse, and for supplying the gate of the thin film transistor with the second gate voltage corresponding to the reset pulse in response to the reset scanning pulse.

A driving method according to the present invention is a method for driving an active matrix display panel having a plurality of pixel sections each including a light emitting element and a thin film transistor, comprising the steps of: supplying a supply voltage to the plurality of pixel sections; and sequentially specifying one of a plurality of rows of the display panel at a predetermined timing for each frame and at least one pixel section including a light emitting diode to be driven for light emission in the one row, supplying a display scanning pulse to each pixel section in the one row, supplying a data pulse indicative of a first gate voltage of the thin film transistor to the at least one pixel section when supplying the display scanning pulse, subsequently supplying a reset scanning pulse each of the pixel sections in the one row, and supplying a reset pulse to the at least one pixel section when supplying the reset scanning pulse, the reset pulse indicating a second gate voltage of the thin film transistor for making the polarity of a gate-to-source voltage or gate-to-drain voltage of the thin film transistor reverse to the polarity during light emission driving, wherein in each of the plurality of pixel sections, a gate of the thin film transistor is supplied with the first gate voltage corresponding to the data pulse in response to the display scanning pulse, and the gate of the thin film transistor is supplied with the second gate voltage corresponding to the reset pulse in response to the reset scanning pulse.

### BRIEF DESCRIPTION OF DRAWINGS

FIGS. 1A and 1B are diagrams showing a change in a gate threshold voltage and a change in the gate voltage-drain current characteristic, respectively;

FIG. 2 is a block diagram showing an embodiment of the present invention;

FIG. 3 is a diagram showing a pixel section of a display panel in the apparatus of FIG. 2, and the configuration of a data signal supply circuit corresponding thereto;

FIG. 4 is a diagram showing periods of a display mode and a reset mode, respectively, in each frame;

FIG. 5 is a diagram showing a setting range of a gate-to-source voltage in each of the display mode and reset mode;

FIG. 6 is a diagram showing the gate-to-source voltage in the display mode and reset mode in each frame;

FIG. 7 is a block diagram showing another embodiment of the present invention;

FIG. 8 is a diagram showing a pixel section of a display panel in the apparatus of FIG. 7, and the configuration of a data signal supply circuit corresponding thereto;

FIG. 9 is a diagram showing periods of the display mode and reset mode, respectively, in each frame;

FIG. 10 is a diagram showing the gate-to-source voltage in the display mode and reset mode in each frame in the case of the apparatus in FIG. 7;

FIG. 11 is a diagram showing the periods of the display mode and reset mode, respectively, in each frame when a sub-field method is applied;

FIG. 12 is a diagram showing the gate-to-source voltage in the display mode and reset mode in each frame when the sub-field method is applied;

FIG. 13 is a diagram showing a pixel section of a display panel in the apparatus of FIG. 7 as another embodiment of the present invention, and the configuration of a data signal supply circuit corresponding thereto; and

FIG. 14 is a diagram showing periods of the display mode and reset mode, respectively, in each frame in the embodiment of FIG. 13.

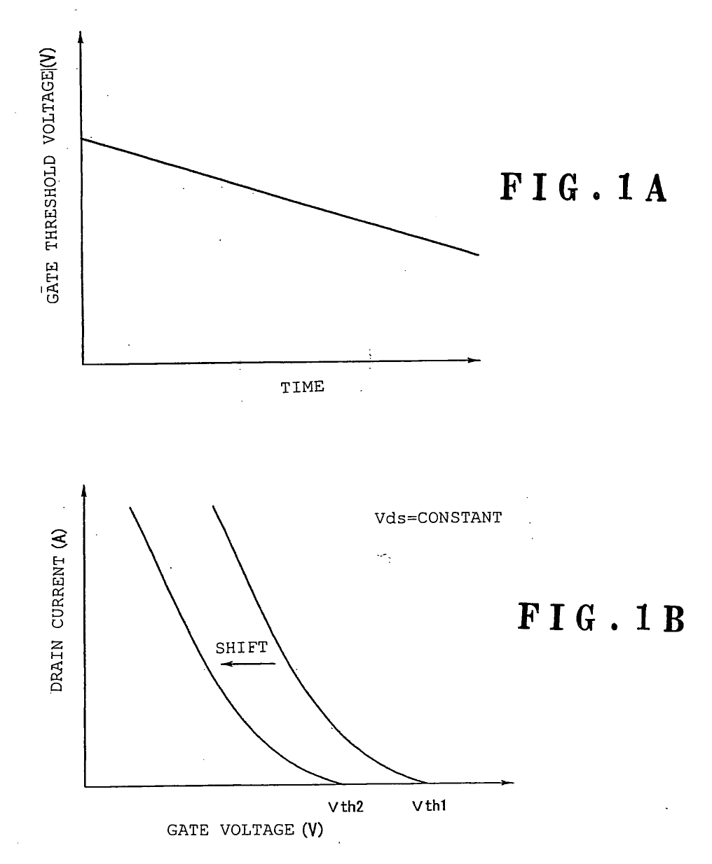

### DETAILED DESCRIPTION OF THE INVENTION

In the following, embodiments of the present invention will be described in detail with reference to the drawings.

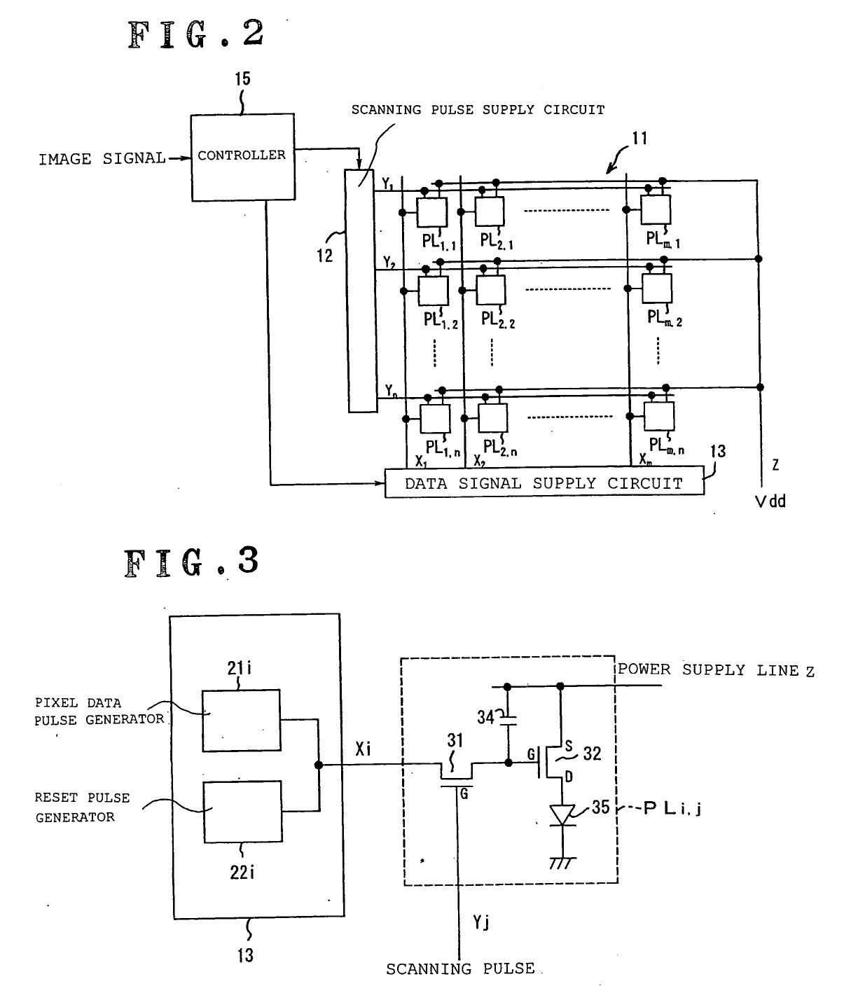

FIG. 2 shows a display apparatus with an active matrix display panel according to the present invention. The display apparatus comprises a display panel 11, a scanning pulse supply circuit 12, a data signal supply circuit 13, and a controller 15.

The display panel 11 is of an active matrix type comprised of m×n pixels (m, n are integers equal to or larger than two), having a plurality of data lines X1-Xm each arranged in parallel, a plurality of scanning lines Y1-Yn, and a plurality of pixel sections PL_{1,1}-PL_{m,n}. The pixel sections PL_{1,1}-PL_{m,n} are arranged at intersections of the data lines X1-Xm with the scanning lines Y1-Yn, and all have the same configuration. Also, the pixel sections pixel sections PL_{1,1}-PL_{m,n} are connected to a power supply line Z. The power supply line Z is supplied with a supply voltage (positive voltage Vdd) from a power source (not shown).

Each of the plurality of pixel sections PL_{1,1}-PL_{m,n} comprises two TFTs (thin film transistors) 31, 32, a capacitor 34, and an organic EL (electroluminescence) element 35. In the pixel section shown in FIG. 3, a data line related thereto is labeled Xi (i is one of 1-m) and a scanning line is labeled Yj (j is one of 1-n).

Each of the two TFTs 31, 32 is a P-channel FET. The TFT 31 has a gate connected to the scanning line Yj, and a source connected to the data line Xi. The TFT 31 has a drain connected to one end of the capacitor 34 and to a gate of the driving TFT 32. The other end of the capacitor 34 and a source of the TFT 32 are connected to the power supply line Z. The TFT 32 has a drain connected to an anode of the EL element 35. The El element 35 has a cathode connected to the ground.

The scanning lines Y1-Yn of the display panel 11 are connected to a scanning pulse supply circuit 12, and the data lines X1-Xm are connected to the data signal supply circuit 13. The controller 15 generates a scanning control signal and a data control signal for driving and controlling the display panel 11 for gradation display in accordance with an input image signal. The scanning control signal is supplied to the scanning pulse supply circuit 12, while the data control signal is supplied to the data signal supply circuit 13.

The scanning pulse supply circuit 12 supplies a display scanning pulse to the scanning lines Y1-Yn in this order in accordance with the scanning control signal at a predetermined timing, and supplies a reset scanning pulse to the scanning lines Y1-Yn in this order at a predetermined timing. The supply of the display scanning pulse and reset scanning pulse is performed every frame of the input image signal. Each scanning line is supplied with the reset scanning pulse in ½ frame period after one display scanning pulse is supplied.

The data signal supply circuit 13 generates a pixel data pulse for each pixel section positioned on a scanning line which is supplied with the scanning pulse in accordance with the data control signal. The pixel data pulse is a data signal indicative of a light emission luminance. The data signal supply circuit 13 supplies the pixel data pulse and reset pulse to at least one pixel section, which should be driven to emit light, through the data lines X1-Xm. Non-light emitting pixel sections are supplied with the pixel data pulse at a level which does not cause the EL element to emit light, and the reset pulse. The data signal supply circuit 13 comprises a pixel data pulse generator and a reset pulse generator for each of data lines X1-Xm. For example, as shown in FIG. 3, a pixel data pulse generator 21i and a reset pulse generator 22i are provided corresponding to a data line Xi. The pixel data pulse generator generates a pixel data pulse, which is supplied to the data lines X1-Xm, in accordance with the data control signal.

Each frame period of an input image signal is divided into a display mode period and a reset mode period, as shown in FIG. 4. The display mode is entered by the generation of the display scanning pulse for each scanning line, and the display mode is changed to the reset mode by the generation of the reset scanning pulse. The display mode and reset mode have temporal lengths equal to each other. In each frame period, the positions of the display mode and reset mode shift in the time direction corresponding to the scanning timing for each scanning line. In the display mode period, the EL elements of those pixel sections which are supplied with the pixel data pulse are driven to emit light. The reset mode period is a non-light emission period, and is a period in which a shift of the gate threshold voltage Vth due to gate stress is suppressed.

During the display mode period, a pixel data pulse is first generated from each of the pixel data pulse generators, and supplied to the data lines X1-Xm. Describing on the assumption that the scanning line applied with the display scanning pulse at that time is the pixel section shown in FIG. 3, the TFT 31 turns on, and the pixel data pulse from the pixel data pulse generator 21i is supplied to the gate of the TFT 32 through the TFT 31 as a first gate voltage. Thus, the capacitor 34 is charged, and the gate-to-source voltage of the TFT 32 for driving the EL element 35 is set to a voltage Vgs-d. Vgs-d≦0V, and for light emission of the EL element, Vgs-d<Vth.

As the reset scanning pulse is supplied to cause a transition to the reset mode subsequent to the display mode, a reset pulse is generated from each of the reset pulse generators simultaneously with that, and supplied to the data lines X1-Xm. Describing the pixel section shown in FIG. 3, similar to the display mode, the TFT 31 turns on in response to the reset scanning pulse, and the reset pulse from the reset pulse generator 22i is supplied to the gate of the TFT 32 through the TFT 31 as a second gate voltage. Thus, the capacitor 34 of the pixel section is charged with the opposite polarity to the display mode, so that the gate-to-source voltage of the TFT 32 is set to a voltage Vgs-r. Vgs-r≧0 V, and there is a relationship of Vgs-r=−Vgs-d.

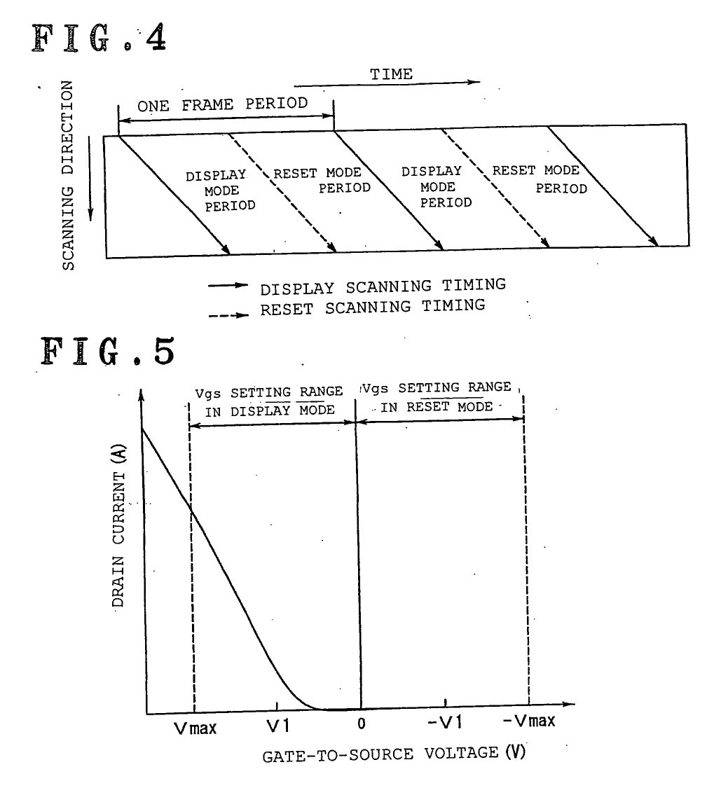

A setting range for the gate-to-source voltage Vgs-d in the display mode period and a setting range for the gate-to-source voltage Vgs-r in the reset mode period can be shown as shown in FIG. 5. When the gate-to-source voltage Vgs-d in the display mode period of one pixel section is V1, the gate-to-source voltage Vgs-r in the reset mode period subsequent thereto is −V1. Vmax is a maximum value of an absolute value of the setting range for Vgs-d, and -Vmax is a maximum value of an absolute value of the setting range for Vgs-r.

The gate-to-source voltage of the driving TFT in each of the display mode and reset mode in each frame of one pixel changes, for example, as shown in FIG. 6. The gate-to-source voltage changes in accordance with the amplitude value of the pixel data pulse, and a drain current in accordance with the gate-to-source voltage flows into the driving TFT and EL element. In each of frames 1-4, the relationship of Vgs-r=−Vgs-d is established. The average of the gate-to-source voltage is 0 V.

Therefore, as the driving TFT is applied with the source-to-gate voltage Vgs-d in each frame, the gate-to-source voltage Vgs-r is applied corresponding thereto, so that the gate stress can be eliminated. As a result, variations in the gate threshold voltage Vth can be suppressed.

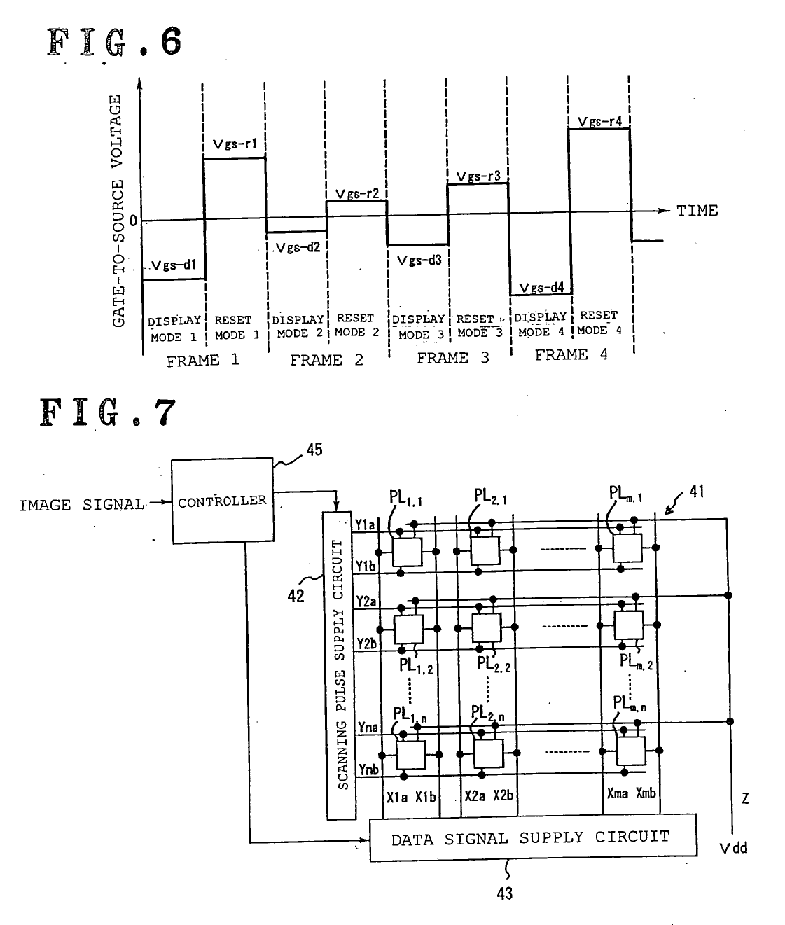

FIG. 7 shows a display apparatus as another embodiment of the present invention. The display apparatus comprises a display panel 41, a scanning pulse supply circuit 42, a data signal supply circuit 43, and a controller 45.

The display panel 41 is of an active matrix type comprised of m×n pixels, and has a plurality of data line pairs X1a, X1b-Xma, Xmb each arranged in parallel, a plurality of scanning line pairs Y1a, Y1b-Yna, Ynb, and a plurality of pixel sections PL_{1,1}-PL_{m,n}. n The pixel sections PL_{1,1}-PL_{m,n} are disposed at intersections of the data line pairs X1a, X1b-Xma, Xmb with the scanning line pairs Y1, Y1b-Yna, Ynb, and all have the same configuration. The data lines X1a-Xma are for pixel data pulses, and the data line pairs X1b-Xmb are for reset pulses. The scanning lines Y1a-Yna are display scanning lines, and the scanning lines Y1b-Ynb are reset scanning lines.

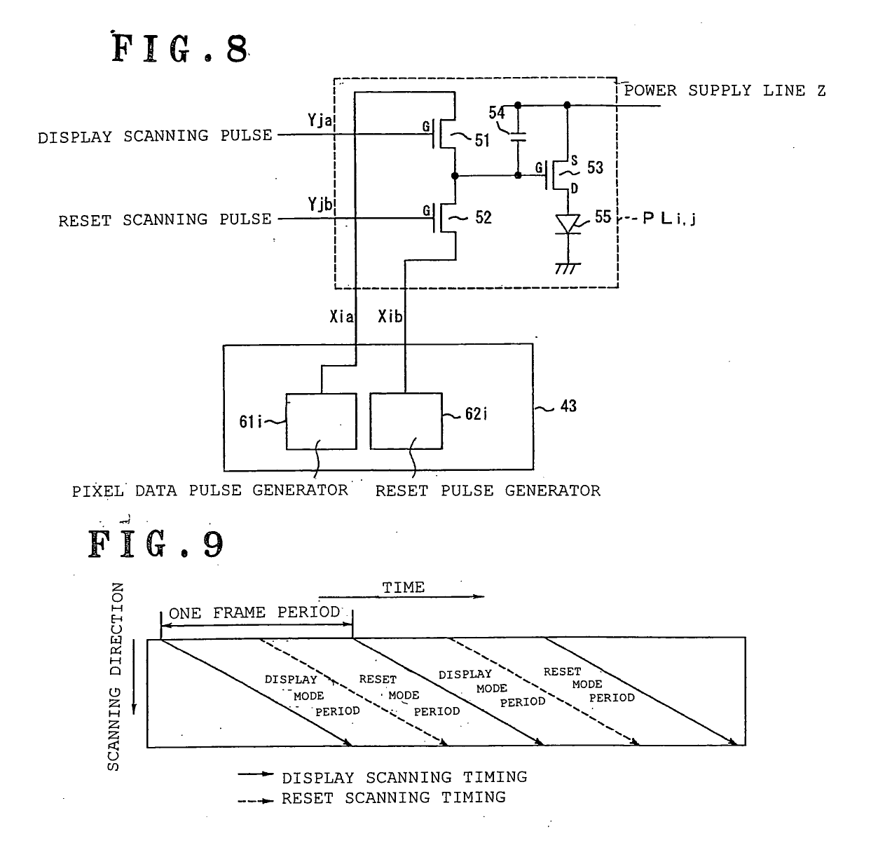

Each of the plurality of the pixel sections PL_{1,1}-PL_{m,n} comprises three TFTs 51-53, a capacitor 54, and an organic EL element 55, as shown in FIG. 8. In the pixel section shown in FIG. 8, a data line pair related thereto is labeled Xia, Xib (i is one of 1-m), and a scanning line pair is labeled Yja, Yjb (j is one of 1-n).

Each of the three TFTs 51-53 is a P-channel FET. The TFT 51, which is for a display mode, has its gate connected to the scanning line Yja, and its source connected to the data line Xia. The TFT 52, which is for a reset mode, has its gate connected to the scanning line Yjb, and its source connected to the data line Xib. The TFTs 51, 52 have their drains connected to one end of the capacitor 54 and to a gate of the driving TFT 53. The other end of the capacitor 54 and a source of the TFT 53 are connected to a power supply line Z. The TFT 53 has a drain connected to an anode of the EL element 55. The EL element 55 has a cathode connected to the ground.

The scanning line pairs Y1a, Y1b-Yna, Ynb of the display panel 41 are connected to a scanning pulse supply circuit 42, and the data line pairs X1a, X1b-Xma, Xmb are connected to a data signal supply circuit 43. The controller 45 generates a scanning control signal and a data control signal for driving and controlling the display panel 11 for gradation display in accordance with an input image signal. The scanning control signal is supplied to the scanning pulse supply circuit 42, and the data control signal is supplied to the data signal supply circuit 43.

The scanning pulse supply circuit 42 supplies a display scanning pulse to the scanning lines Y1a-Yna in this order at a predetermined timing in accordance with the scanning control signal, and supplies the reset scanning pulse to the scanning lines Y1b-Ynb in this order at a predetermined timing. The supply of each scanning pulse is performed every frame of the input image signal. A scanning period of the display scanning pulse and the scanning period of the reset scanning pulse for one frame is the same in length. For the same frame, scanning by the reset scanning pulse is started with a delay of ½ scanning period from the start of scanning by the display scanning pulse.

The data signal supply circuit 43 comprises a pixel data pulse generator for each data line X1a-Xma, and a reset pulse generator for each data line X1b-Xmb. For example, as shown in FIG. 8, a pixel data pulse generator 61i is provided corresponding to a data line Xib, and a reset pulse generator 62i is provided corresponding to a data line Xib. The pixel data pulse generator generates a pixel data pulse for each of pixel sections positioned on a scanning line supplied with the display scanning pulse in accordance with the data control signal, and supplies it to each pixel section through the data lines X1a-Xma. Also, the reset pulse generator generates a reset pulse for each of pixels positioned on a scanning line supplied with the reset scanning pulse in accordance with the data control signal, and supplies it to each pixel section through the data lines X1b-Xmb. Non-light emitting pixel sections are supplied with a pixel data pulse at a level which does not cause the EL element to emit light, and the reset pulse.

As shown in FIG. 9, each frame of an input image signal is divided into the display mode and reset mode. The display mode and reset mode have temporal lengths equal to each other. In each frame period, the positions of the display mode and reset mode shift in the time direction corresponding to a scanning timing for each scanning line. As can be seen from FIG. 9, a scanning speed of the display apparatus in FIG. 7 is one half as compared with a scanning speed (FIG. 4) of the display apparatus shown in FIG. 2.

In the display mode, each of the pixel data pulse generators first generates a pixel data pulse which is supplied to the data line X1a-Xma. Describing on the assumption that the scanning line applied with the display scanning pulse at that time is the pixel section shown in FIG. 8, the TFT 51 is turned on by the display scanning pulse to charge the capacitor 54 of the pixel section in accordance with the pixel data pulse, and the gate-to-source voltage of the TFT 53 for driving the EL element 55 is set to a voltage Vgs-d. Vgs-d≦0V, and for light emission of the EL element, Vgs-d<Vth.

As the reset mode is entered subsequent to the display mode, a reset pulse is generated from each of the reset pulse generators 62₁-62ₘ and supplied to the data lines X1b-Xmb. Describing the pixel section shown in FIG. 8, similar to the display mode, the TFT 52 is turned on by the reset scanning pulse to charge the capacitor 34 of the pixel section in accordance with the reset pulse in the opposite polarity to the display mode to set the gate-to-source voltage of the TFT 53 to a voltage Vgs-r. Vgs-r≧0 V, and there is a relationship of Vgs-r=−Vgs-d.

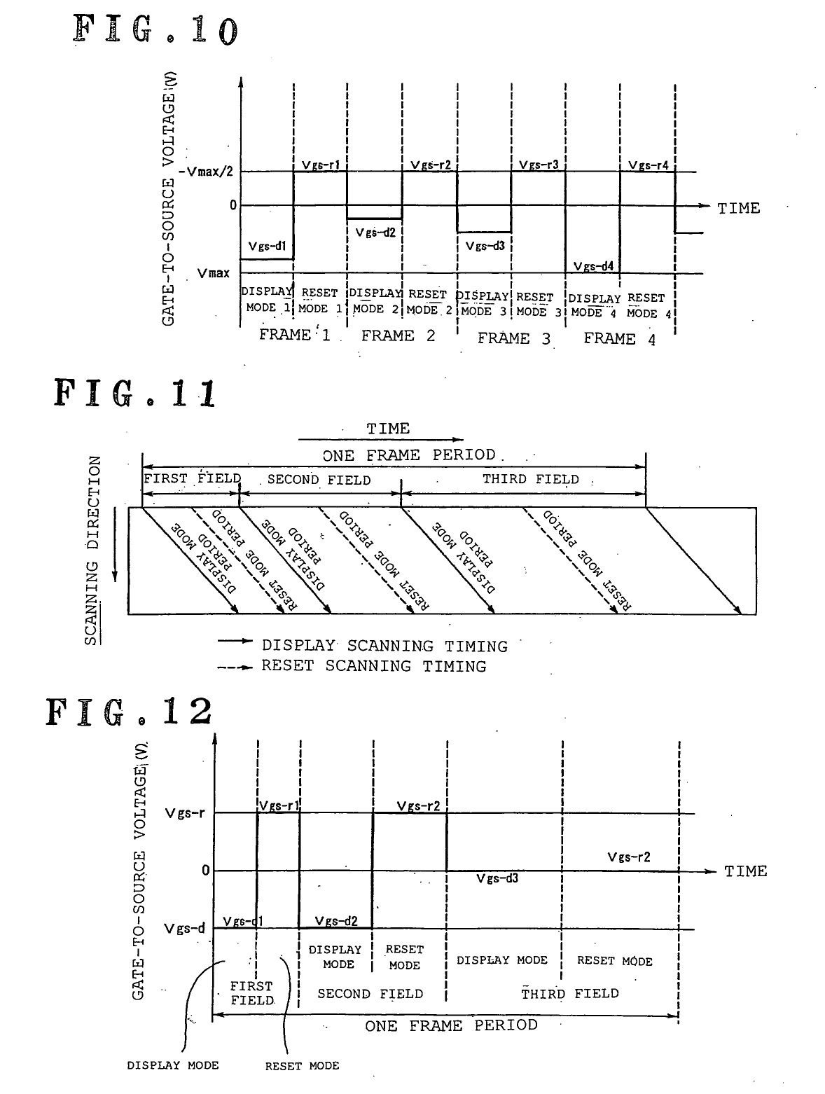

Instead of Vgs-r=−Vgs-d, Vgs-r may be set at a voltage which mitigates the gate stress. For example, Vgs=k×Vgs-d, where k is an arbitrary negative constant. Alternatively, Vgs-r may be set to a negative fixed value C, as Vgs-r=C. When Vgs-r=−Vmax/2, the gate-to-source voltage of the driving TFT in each of the display mode and reset mode in each frame of one pixel section changes as shown in FIG. 10. While the gate-to-source voltage Vgs-d changes in accordance with the amplitude value of the pixel data pulse, Vgs-r is set at −Vmax/2 at all times.

In each of the embodiments described above, the display mode period and reset mode period in each frame are equal, but they may be different periods from each other.

Also, while in each of the embodiments described above, a method of displaying one frame as one field has been described, the present invention may be applied to an apparatus which drives a display panel using a so-called sub-field method which divides one frame period into a plurality of field periods.

As a display apparatus using the sub-field method, the configuration shown in FIG. 7 can be used, and further, as each of the plurality of pixel sections PL_{1,1}-PL_{m n}, the configuration shown in FIG. 8 can be used as it is. Each frame period of an input image signal is divided into three field periods, for example, as shown in FIG. 11. Also, each field is provided with a display mode period and a reset mode period. Specifically, a first display mode and a first reset mode exist in a first field; a second display mode and a second reset mode exist in a second field; and a third display mode and a third reset mode exist in a third field. The first display mode and first reset mode have time lengths equal to each other, and have a shorter period than each of the other modes. The second display mode and second reset mode have time lengths equal to each other. The third display mode and third reset mode have time length equal to each other, and have a longer period than each of the other modes.

In the display apparatus using the sub-field method, in a field period in which the EL element of the pixel section is driven to emit light, the gate-to-source voltage of the TFT 53 is set at a voltage Vgs-d during the display mode period of the first and second fields, as shown in FIG. 12. This voltage Vgs-d is a voltage which turns the TFT 53 on. In the reset mode period of the first and second fields, the gate-to-source voltage of the TFT 53 is set at a voltage −Vgs-d (=Vgs-r). On the other hand, in a field in which the EL element of the pixel section is prohibited from emitting light, the gate-to-source voltage of the TFT 53 is set at 0 V during the display mode period of the third field to turn the TFT 53 off. The gate-to-source voltage of the TFT 53 is set at 0 V during the reset mode period of the third field. However, in a non-light emission field, the gate-to-source voltage may be a voltage Voff (Voff<0) other than 0 V in the display mode, as long as it turns off the TFT 53, and the gate-to-source voltage is set at −Voff during the reset mode period corresponding thereto.

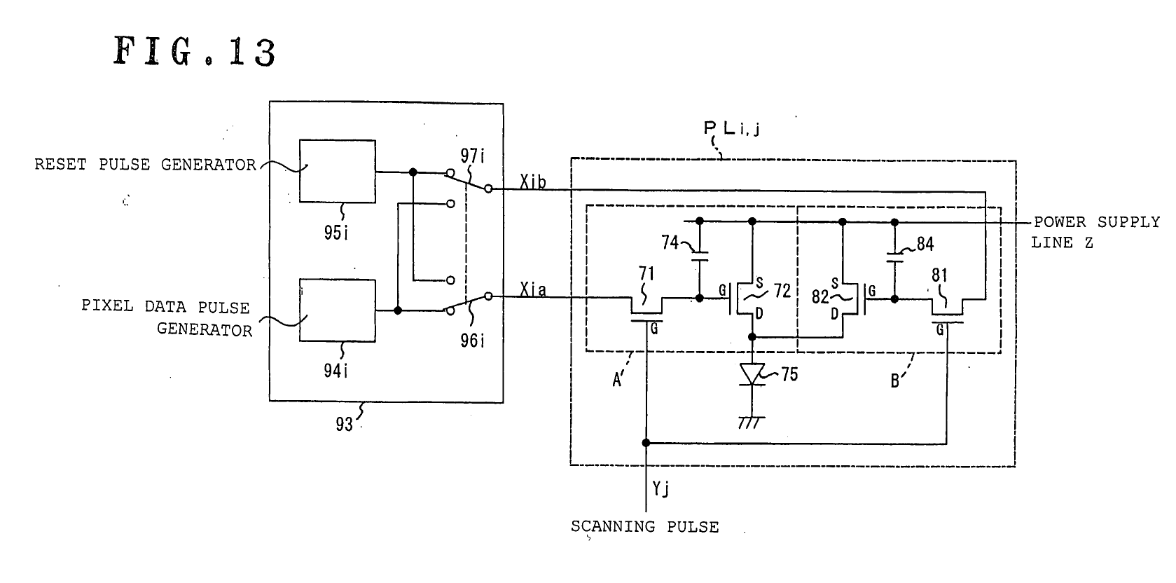

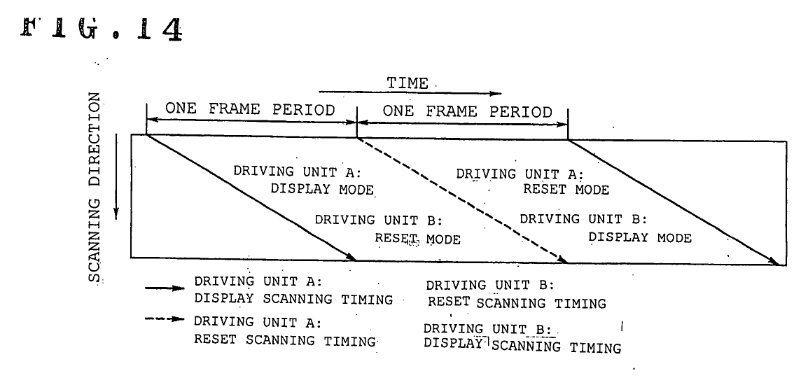

FIG. 13 shows a pixel section as another embodiment of the present invention. This pixel section comprises two sets (driving units A, B) of the configuration of the pixel section shown in FIG. 3 except for the EL element. Specifically, with an organic EL element 75 used in common, the driving unit A comprises two TFTs 71, 72 and a capacitor 74, while the driving unit B comprises two TFT 81, 82 and a capacitor 84. For one pixel section, two data lines Xia, Xib and one scanning line Yj are related. The data line Xia is connected to a source of the TFT 71, the data line Xib is connected to a source of the TFT 81, and the scanning line Yj is connected to gates of the TFTs 71, 81.

In an odd-numbered frame period, the data line Xia is supplied with a pixel data pulse from a pixel data pulse generator 94i in a data signal supply circuit 93 through a switch 96i. In an even-numbered frame period, the data line Xia is supplied with a reset pulse from a reset pulse generator 95i in the data signal supply circuit 93 through the switch 96i. In an odd-numbered frame period, the data line Xib is supplied with a reset pulse from the reset pulse generator 95i in the data signal supply circuit 93 through a switch 97i. In an even-numbered frame period, the data line Xib is supplied with a pixel data pulse from the pixel data pulse generator 94i in the data signal supply circuit 93 through the switch 97i.

Therefore, as shown in FIG. 14, in each frame of an input image signal, the driving unit A enters the display mode period in the frame 1 to drive the EL element 75 in accordance with the pixel data pulse, while the driving unit B enters the reset mode period to eliminate the gate stress of the driving TFT 82 in accordance with the reset pulse. In the frame 2, the driving unit A enters the reset mode period to eliminate the gate stress of the driving TFT 72 in accordance with the reset pulse, while the driving unit B enters the display mode period to drive the EL element 75 in accordance with the pixel data pulse. In the driving unit A, when the gate-to-source voltage of the TFT 72 is Vgs-d during the display mode period, the gate-to-source voltage Vgs-r of the TFT 72 is set at −Vgs-d during the reset mode period of the next frame. Similarly, in the driving unit B, when the gate-to-source voltage of the TFT 82 during the display mode period is Vgs-d, the gate-to-source voltage Vgs-r of the TFT 82 is set at −Vgs-d during the reset mode period of the next frame.

While in each of the foregoing embodiments described above, description has been made on a display panel using P-channel TFTs, the present invention can be applied as well to a display panel using N-channel TFTs. In the embodiment shown in FIG. 3, while the TFT 31 has the source connected to the data line Xi, and the drain connected to one end of the capacitor 34 and to the gate of the driving TFT 32, the source may be connected to the one end of the capacitor 34 and to the gate of the driving TFT 32. Also, the FETs 51, 52 in the embodiment shown in FIG. 8, and the FETs 71, 81 of the embodiment shown in FIG. 13 may also have their drains and sources connected in reverse.

Further, in the embodiments described above, upon supply of the reset scanning pulse, the selected pixels are individually supplied with a reset pulse for inverting the polarity of the gate-to-source voltage of the thin film transistor to that during light emission driving. Alternatively, the reset pulse may be supplied individually for inverting the polarity of the gate-to-drain voltage of the thin film transistor to that during the light emission driving.

Also, each pixel section of the display panel is not limited to the configuration by a combination of the aforementioned data setting TFT with driving TFT, but a circuit of current program system may be used.

Also, in each of the embodiments described above, while description has been made on the case where organic EL elements are used as light emitting elements, the present invention can be applied to light emitting elements of other current driving types such as inorganic LED, FED (Field Emission Display), and the like.

As described above, according to the present invention, since a gate voltage is applied to invert the polarity of a gate-to-source voltage of a driving TFT to that during light emission driving each time EL elements are driven to emit light, the gate stress can be suppressed to prevent a degradation of the display quality.

1. A display apparatus with an active matrix display panel having a plurality of pixel sections each including a light emitting element and a thin film transistor, said display apparatus comprising:
a power supply for supplying a supply voltage to said plurality of pixel sections; and
display control means for sequentially specifying one of a plurality of rows of said display panel at a predetermined timing for each frame and at least one pixel section including a light emitting diode to be driven for light emission in the one row, supplying a display scanning pulse to each pixel section in the one row, supplying a data pulse indicative of a first gate voltage of said thin film transistor to the at least one pixel section when supplying the display scanning pulse, subsequently supplying a reset scanning pulse each of said pixel sections in the one row, and supplying a reset pulse to the at least one pixel section when supplying the reset scanning pulse, the reset pulse indicating a second gate voltage of said thin film transistor for making the polarity of a gate-to-source voltage or gate-to-drain voltage of said thin film transistor reverse to the polarity during light emission driving, wherein:
each of said plurality of pixel sections has a driving unit for supplying a gate of said thin film transistor with the first gate voltage corresponding to the data pulse in response to the display scanning pulse, and for supplying the gate of said thin film transistor with the second gate voltage corresponding to the reset pulse in response to the reset scanning pulse.

2. A display apparatus according to claim 1, wherein an absolute value of the gate-to-source voltage or gate-to-drain voltage of said thin film transistor depending on the first gate voltage is equal to an absolute value of the gate-to-source voltage or gate-to-drain voltage of said thin film transistor depending on the second gate voltage.

3. A display apparatus according to claim 1, wherein the gate-to-source voltage or gate-to-drain voltage of said thin film transistor depending on said second gate voltage is a fixed voltage.

4. A display apparatus according to claim 1, wherein each frame period has a display mode period in which the gate of said thin film transistor is supplied with the first gate voltage, and a reset mode period in which the gate of said thin film transistor is supplied with the second gate voltage.

5. A display apparatus according to claim 1, wherein a pixel section which is in a display mode period in which the gate of said thin film transistor is supplied with the first gate voltage in one frame period changes to a reset mode period in which the gate of said thin film transistor is supplied with said second gate voltage in the next frame period.

6. A display apparatus according to claim 5, wherein said pixel section comprises two equivalent driving circuits each have said thin film transistor, and said two driving circuits alternately switch the display mode and the reset mode.

7. A display apparatus according to claim 4, wherein the display mode period and said reset mode period are repeated based on a sub-field method in each frame period.

8. A display apparatus according to claim 1, wherein said light emitting element is an organic electroluminescence element.

9. A display apparatus according to claim 1, wherein said thin film transistor is an amorphous silicon thin film transistor.

10. A display apparatus according to claim 1, wherein said thin film transistor is an organic semiconductor thin film transistor.

11. A method for driving an active matrix display panel having a plurality of pixel sections each including a light emitting element and a thin film transistor, comprising the steps of:
supplying a supply voltage to said plurality of pixel sections; and
sequentially specifying one of a plurality of rows of said display panel at a predetermined timing for each frame and at least one pixel section including a light emitting diode to be driven for light emission in the one row, supplying a display scanning pulse to each pixel section in the one row, supplying a data pulse indicative of a first gate voltage of said thin film transistor to the at least one pixel section when supplying the display scanning pulse, subsequently supplying a reset scanning pulse each of said pixel sections in the one row, and supplying a reset pulse to the at least one pixel section when supplying the reset scanning pulse, the reset pulse indicating a second gate voltage of said thin film transistor for making the polarity of a gate-to-source voltage or gate-to-drain voltage of said thin film transistor reverse to the polarity during light emission driving, wherein:
in each of said plurality of pixel sections, a gate of said thin film transistor is supplied with the first gate voltage corresponding to the data pulse in response to the display scanning pulse, and the gate of said thin film transistor is supplied with the second gate voltage corresponding to the reset pulse in response to the reset scanning pulse.

12. A display method according to claim 11, wherein said light emitting element is an organic electroluminescence element.

13. A display method according to claim 11, wherein said thin film transistor is an amorphous silicon thin film transistor.

14. A display method according to claim 11, wherein said thin film transistor is an organic semiconductor thin film transistor.
